(19) United States
(12) Patent Application Publication
(10) Pub. No.: US 2024/0342638 A1
(43) Pub. Date: Oct. 17, 2024

(54) FILTER ELEMENT, FILTER HOUSING PART, FILTER SYSTEM, AND METHOD OF ARRANGING FILTER ELEMENT IN FILTER SYSTEM

(71) Applicant: MANN+HUMMEL GmbH, Ludwigsburg (DE)

(72) Inventors: Jochen LINHART, Schwaikheim (DE); Frank PFLÜGER, Sachsenheim (DE)

(21) Appl. No.: 18/642,773

(22) Filed: Apr. 22, 2024

Related U.S. Application Data
(63) Continuation of application No. PCT/EP2022/080124, filed on Oct. 27, 2022.

(30) Foreign Application Priority Data
Nov. 3, 2021 (DE) 102021128604.2

(51) Int. Cl. B01D 46/00; B01D 46/52

(52) U.S. Cl. CPC B01D 46/0005; B01D 46/521; B01D 2201/291

(57) ABSTRACT

A filter element for a filter system includes a filter medium, one or more end disks, and two or more filter element-associated fastening elements arranged at the one or more end disks, wherein the two or more filter element-associated fastening elements are arranged concentrically around a fastening element center axis of the filter element extending in a longitudinal direction, and the fastening element center axis of the filter element is radially offset in relation to at least one further center axis.

### CROSS-REFERENCE TO RELATED APPLICATIONS

This application is a continuation application of International Application No. PCT/EP2022/080123 filed on Oct. 27, 2022, which claims the benefit of German Application No. 102021128603.4 filed on Nov. 3, 2021, the entire disclosures of which are incorporated herein by reference for all purposes.

### BACKGROUND

The invention concerns a filter element for a filter system, a filter housing part for a filter system, a corresponding filter system with such a filter element and such a filter housing part, and a use of a filter element in such a filter system.

Filter systems with exchangeable filter elements are known to a person of skill in the art. The filter systems comprise a housing in which an exchangeable filter element is arranged, wherein a filter medium of the filter element filters a fluid flow flowing through the filter element. The housing can comprise at least two housing parts which are detachably connected to each other. The housing parts form in the connected state a cavity in which the filter element is exchangeably arranged. At least one of the housing parts comprises at least one opening. By releasing the at least one opening, the fluid in the housing can be drained from the housing.

An exchangeable filter element comprises in general a filter medium which is designed, for example, in a hollow-cylindrical shape and is flowed through by a fluid to be purified from an outer side to an inner side and which is closed off at two oppositely positioned ends by at least two end disks. The filter medium can be supported by a center tube from the interior against the hydraulic pressure of the flowing fluid. At least one end disk can comprise at least one opening. By releasing the at least one opening, the fluid in the housing can be drained from the housing.

Corresponding uses of a filter element in such a filter system are also known to a person of skill in the art.

US 2020/0114286 A1 describes a filter component group comprising a filter element housing plate which is positioned between a high-pressure side and a low-pressure side of the arrangement, wherein the filter element housing plate comprises at least one cavity. At least one exchangeable filter element is arranged inside the filter arrangement, wherein each exchangeable filter element comprises an end cap with an outer rounded polygonal seal surface which engages the circumferential surfaces of an associated cavity of the filter element housing plate and seals the filter element housing plate against circumferential surfaces of the cavity. The housing plate comprises at least one latch for each filter element which engages the end cap of the filter element and is fastened thereto in order to secure the exchangeable filter element in a predetermined position.

DE 202015000633 U1 describes a filter cartridge, comprising a filter medium with a first and a second end, a first end plate coupled to the first end of the filter medium, and a second end plate coupled to the second end of the filter medium. The second end plate comprises at least one tab formed at an outer circumferential surface of the second end plate. The at least one tab comprises at least one tab rib extending away from it. The at least one tab rib is arranged for the optional engagement with a corresponding filter jacket. The tab or each tab defines a pocket which can be gripped by a user when the filter cartridge is installed in the filter jacket.

EP 3666363 A1 discloses a fluid filter element. The fluid filter element comprises a filter medium which is arranged in a cylindrical arrangement around a longitudinal axis. The fluid filter element comprises furthermore a first and a second end disk which are arranged at oppositely positioned cylindrical ends of the filter medium and are sealed therewith, wherein the second end disk defines an outlet for filtered fluid. The fluid filter element comprises furthermore at least one locking projection arranged at the second end disk for rotary locking of the fluid filter at the filter support by rotating the fluid filter element around the longitudinal axis in a first rotational direction in relation to the filter support. The fluid filter element comprises in addition at least one releasable holder arranged at the second end disk and associated with the at least one locking projection in order to hold the at least one locking projection in locking engagement with the filter support and which, when it is released, enables a rotary unlocking of the fluid filter element from the filter support by rotating the fluid filter element around the longitudinal axis in a second rotational direction in relation to the filter support opposite to the first rotational direction.

### SUMMARY

It is an object of the invention to provide a filter element of a filter system which can be fixed reliably in a state of use at a filter housing part.

A further object of the invention is to provide a filter housing part of a filter system at which a filter element can be fixed reliably in a state of use.

A further object of the invention is to provide a filter system which comprises a filter element and a filter housing part, wherein the filter element is fixed reliably by a fastening arrangement in a state of use at the filter housing part.

A further object of the invention is providing a use of a filter element in a filter system which can be realized in a simple manner.

The aforementioned object is solved by a filter element of a filter system with at least two filter element-associated fastening elements which are arranged concentrically around the same fastening element center axis of the filter element extending in longitudinal direction. The fastening element center axis of the filter element is arranged offset in relation to at least one further filter element center axis of the filter element extending in longitudinal direction; or offset in relation to at least one filter housing part center axis, extending in longitudinal direction, of a filter housing part in which the filter element in a state of use is arranged; or offset in relation to at least one of the further filter element center axes of the filter element extending in longitudinal direction and offset in relation to at least one filter housing part center axis of the filter housing part extending in longitudinal direction. The at least two fastening elements comprise a different radial distance in relation to the at least one further center axis in relation to which the fastening element center axis of the filter element, around which the fastening elements are arranged, is offset.

A further object is solved by a filter housing part for a filter system with at least two housing part-associated fastening elements which are arranged concentrically around the same fastening element center axis of the filter housing part extending in longitudinal direction. The fastening element center axis of the filter housing part is arranged offset in relation to at least one further filter housing part center axis of the filter housing part extending in longitudinal direction; or offset in relation to at least one filter element center axis, extending in longitudinal direction, of the filter element which in a state of use is arranged in the interior; or offset in relation to at least one of the further filter housing part center axes of the filter housing part extending in longitudinal direction and offset in relation to at least one filter element center axis of the filter element extending in longitudinal direction. The at least two housing part-associated fastening elements comprise a different radial distance in relation to the at least one further center axis in relation to which the fastening element center axis of the filter housing part, around which the housing part-associated fastening elements are arranged, is offset. The fastening element center axis of the filter element, around which the at least two filter element-associated fastening elements are concentrically arranged is arranged in a state of use congruently in relation to the fastening element center axis of the filter housing part around which the at least two housing part-associated fastening elements are concentrically arranged.

A further object is solved by a filter system with a filter housing part which comprises an interior, an opening coupled to the interior, and at least two housing part-associated fastening elements which are arranged concentrically around a fastening element center axis of the filter housing part. In the interior of the filter housing part, a filter element is arranged in a state of use. The filter element comprises a filter medium and at least one end disk. At least two filter element-associated fastening elements are arranged concentrically around a fastening element center axis of the filter element at the end disk. In the state of use, the filter element is detachably attached to the filter housing part by a fastening arrangement which comprises the at least two filter element-associated fastening elements and at least two housing part-associated fastening elements interacting therewith. The fastening element center axis of the filter element, around which the at least two filter element-associated fastening elements are concentrically arranged, is arranged offset in relation to at least one further filter element center axis of the filter element and/or offset in relation to at least one filter housing part center axis of the filter housing part. The fastening element center axis of the filter housing part, around which the at least two housing part-associated fastening elements are concentrically arranged, is arranged offset in relation to at least one further filter housing part center axis of the filter housing part and/or offset in relation to at least one filter element center axis of the filter element. In the state of use, the fastening element center axes of the filter housing part and of the filter element, around which the corresponding fastening elements are arranged, are congruently arranged in relation to each other.

A further object is solved by the use of a filter element in a filter system, wherein the filter element is inserted into an interior of a filter housing part and is oriented in relation to the filter housing part such that the fastening element center axis of the filter element, around which at least two filter element-associated fastening elements are concentrically arranged, is congruently arranged in relation to a fastening element center axis of the filter housing part around which the at least two housing part-associated fastening elements are concentrically arranged. The at least two filter element-associated fastening elements are oriented such in relation to the at least two housing part-associated fastening elements that the fastening elements form a fastening arrangement for detachable fastening of the filter element at the filter housing part.

Beneficial embodiments and advantages of the invention result from the additional claims, the description, and the drawing.

According to an aspect of the invention, a filter element with a filter medium and at least one end disk is proposed, wherein at the end disk at least two filter element-associated fastening elements are arranged which are arranged concentrically around the same fastening element center axis of the filter element extending in longitudinal direction. The at least one end disk can comprise an opening with at least one opening center axis extending in longitudinal direction. The fastening element center axis of the filter element is arranged offset in relation to at least one filter element center axis of the filter element extending in longitudinal direction; or offset in relation to at least one filter housing part center axis, extending in longitudinal direction, of a filter housing part in which the filter element in the state of use is arranged; or offset in relation to at least one of the further filter element center axes of the filter element extending in longitudinal direction and offset in relation to at least one filter housing part center axis of the filter housing part extending in longitudinal direction. The at least two fastening elements comprise a different distance to the at least one further center axis in relation to which the fastening element center axis of the filter element, around which the filter element-associated fastening elements are arranged, is offset.

End disk is understood herein as a terminal closure disk which is connected directly to a filter medium body formed of the filter medium but also as an element which is separate therefrom, which comprises a disk shape and, for example, is arranged at a center tube of the filter element.

A center axis is understood in the following as an axis which extends in longitudinal direction of the filter element or of the filter housing part and which extends centrally through a cross section of a corresponding element or centrally through a cross section of a section of the element. The cross sections can be round or angular.

In this context, a filter element center axis can be an opening center axis, a seal section center axis, an end disk center axis, a center tube center axis, a filter medium center axis or another center axis extending in longitudinal direction through another element of the filter element.

In this context, a filter housing part center axis can be an opening center axis, a connection section center axis, a seal section center axis or another center axis extending in longitudinal direction through another element of the filter housing part.

The cross sections of the elements or the cross sections of the sections of the elements can have rotational symmetry in relation to the corresponding center axis or mirror symmetry to at least one plane or axis extending through the corresponding center axis.

The filter element can comprise a plurality of elements and therefore a plurality of center axes. For example, the end disks each can comprise a cross section with a corresponding end disk center axis. In addition, a center tube which can support the filter element at least partially from the interior and which is arranged at the end disk can comprise a center tube center axis. A jacket which can at least partially surround the filter element from the exterior can comprise a jacket center axis. In addition, openings of the end disks can each comprise an opening center axis. It is also conceivable that an element comprises a plurality of sections with corresponding center axes. The filter medium center axis of the filter medium can be a central center axis of the filter element in relation to which the fastening element center axis can be arranged offset.

The center axes of the elements can be arranged congruently or offset in relation to each other. For example, the jacket and the center tube or the jacket or the center tube can be arranged centrally or off-center at the end disk. In this context, the jacket center axis of the jacket or the center tube center axis of the center tube can be arranged offset in relation to the end disk center axis of the end disk. In addition, the jacket center axis of the jacket or the center tube center axis of the center tube can be arranged congruently or offset in relation to the opening center axis of the at least one opening in the end disk. An offset arrangement of the jacket center axis of the jacket or of the center tube center axis of the center tube in relation to the end disk center axis of the end disk, or in relation to the opening center axis of the opening, or in relation to the end disk center axis of the end disk and to the opening center axis of the opening is also conceivable. A plurality of end disks can comprise congruent end disk center axes or end disk center axes which are arranged offset in relation to each other. In addition, elements arranged at the respective end disks can comprise center axes which are arranged congruently or offset in relation to each other.

The filter element can be arranged centrally or off-center at the filter housing part.

An offset arrangement is understood in the following such that the center axes arranged offset in relation to each other are in particular radially offset in relation to each other.

The fastening element center axis of the filter element, around which the at least two filter element-associated fastening elements are arranged, forms the center point of at least one circular surface, wherein the at least two filter element-associated fastening elements are arranged on a circumference of the respective circular surface, wherein the distance of the fastening elements in relation to the fastening element center axis of the filter element is predetermined by the radius of the circular surface. In this context, the at least two filter element-associated fastening elements can be arranged on the circumference of the same circular surface or on the circumference of different circular surfaces around this fastening element center axis, respectively. The filter element can comprise, for example, two, three, four or more fastening elements. In this context, all fastening elements can be arranged on the circumference of the same circular surface or on the circumference of different circular surfaces, respectively. In addition, an arrangement is conceivable in which at least two fastening elements are arranged on the circumference of the same circular surface and the other fastening elements are arranged on the circumference of at least one other circular surface. The arrangement of the at least two filter element-associated fastening elements is substantially only limited in that the filter element-associated fastening elements are arranged off-center in relation to the center axis in relation to which the fastening element center axis of the filter element, around which the at least two filter element-associated fastening elements are arranged, is offset. In this way, the fastening elements are arranged asymmetrically in relation to at least one filter element center axis of the filter element and/or to at least one filter housing part center axis of the filter housing part. In this context, the at least two filter element-associated fastening elements can be arranged at the end disk independent of a geometry of the filter element or of a geometry of the filter housing part so that a larger variety of arrangements of the at least two filter element-associated fastening elements can be achieved. In this context, the at least two filter element-associated fastening elements are arranged on a surface of the end disk or of a center tube, which surface is facing away from the filter medium, or an end disk section formed at the center tube. The arrangement of the at least two filter element-associated fastening elements can be adapted, for example, to the installation space in a corresponding filter system.

Since a fastening arrangement comprises at least two fastening element pairs, wherein each fastening element pair comprises a respective filter element-associated fastening element and a housing part-associated fastening element, the arrangement of the at least two filter element-associated fastening elements depends in addition on the arrangement of the at least two housing part-associated fastening elements because, for the realization of an effective connection, a complementary arrangement of the at least two filter element-associated fastening elements and of the at least two housing part-associated fastening elements is advantageous.

Due to the off-center arrangement of the at least two filter element-associated fastening elements in relation to one of the filter element center axes of the filter element and/or to one of the filter housing part center axes of the filter housing part, the at least two filter element-associated fastening elements can also be arranged expediently at the end disk when the filter element, or one of the elements of the filter element, is arranged off-center or eccentrically in the filter housing part. In addition, it can be effected that only filter elements constructed for the corresponding filter housing part can be fastened at the filter housing part. In this way, an installation of filter elements which are not constructed for the corresponding filter housing part can be made difficult or prevented so that the functionality of a corresponding filter arrangement is improved, and the observance of a quality standard can be facilitated. In addition, by means of the filter element-associated fastening elements and the housing part-associated fastening elements, an orientation of the filter element in the filter housing part can be predetermined. A user, due to the successful joining of the at least two filter element-associated fastening elements and of the at least two housing part-associated fastening elements, can easily detect whether the correct filter element has been arranged at the intended position in the intended orientation in the filter housing part. Due to the offset of the fastening element center axis of the filter element, around which the at least two filter element-associated fastening elements are arranged, in relation to at least one of the filter element center axes of the filter element and/or to at least one of the filter housing part center axes of the filter housing part, mounting errors such as mounting an unsuitable filter element in the filter housing part or insertion at a different orientation than the intended orientation can be avoided or at least made difficult. In addition, due to the fastening arrangement, an insertion depth of the filter element in the filter housing part that is too small or too large can be avoided or at least made difficult.

Due to the fastening element center axis of the filter element, around which the at least two filter element-associated fastening elements are arranged, an orientation point for the at least two housing part-associated fastening elements can be provided in addition. In this way, the arrangement of the at least two housing part-associated fastening elements at the filter housing part in case of asymmetric and/or offset and/or eccentric arrangement of the filter element in the filter housing part or of the at least two filter element-associated fastening elements can be facilitated. In particular, the arrangement of the at least two housing part-associated fastening elements at the filter housing part can be facilitated when the filter element is arranged off-center in the filter housing part. Furthermore, due to the orientation point, the arrangement of the housing part-associated fastening elements at the filter housing part can be facilitated, despite asymmetric and/or eccentric and/or offset arrangement of different elements the filter element or of various elements of the filter housing part. Due to the orientation point, the creation of the fastening arrangement with pairs of filter housing part-associated and filter element-associated fastening elements can be facilitated. In addition, joining of the at least two housing part-associated fastening elements and the at least two filter element-associated fastening elements can be facilitated.

A state of use is understood in the following as a state in which the filter element is fastened by the fastening arrangement at the filter housing part. In this way, it can be ensured that the filter element while being flowed through by a fluid is fixed in a predetermined position in the filter housing part. In addition, the insertion of a closure element into the opening of the end disk can be facilitated by the fixation of the filter element at the filter housing part. In addition, the filter housing part can be moved together with the fixed filter element. For example, a filter housing part embodied as a cover can be lifted off a further filter housing part and together therewith also the filter element. In this way, emptying of the housing formed of the filter housing parts or the exchange of the filter element can be facilitated.

According to a beneficial embodiment, the filter element can be pleated to an in particular star-shaped folded bellows. Other shapes are also conceivable. The further center axis in relation to which the fastening element center axis of the filter element is offset, can be a folded bellows center axis in this context. In this context, the Acentral center axis@ of the filter element can be defined by the folded bellows center axis of the folded bellows because the latter is preferably embodied with identical fold heights in circumferential direction. However, embodiments are possible also in which the filter medium is arranged in the form of a wound body.

In addition or as an alternative, the at least one end disk can comprise an opening with at least one opening center axis extending in longitudinal direction. In particular, the further center axis in relation to which the fastening element center axis of the filter element is radially offset, can be preferably the opening center axis of the opening.

Due to the off-center arrangement of the at least two filter element-associated fastening elements in relation to the folded bellows center axis and/or to the opening center axis, only filter elements which are constructed for the corresponding filter housing part can be attached to the filter housing part. In this context, filter housing parts can comprise individually designed filter elements, wherein an installation of filter elements which are not constructed for the corresponding filter housing part can be made difficult or prevented. In this way, the functionality of a corresponding filter arrangement can be improved and the compliance with a quality standard can be facilitated. Due to the offset of the fastening element center axis of the filter element, around which the at least two filter element-associated fastening elements are arranged, in relation to the folded bellows center axis or to the opening center axis, mounting errors such as mounting a filter element in an unsuitable filter housing part or the insertion in a different orientation than the intended orientation can thus be prevented or at least made difficult.

According to a beneficial embodiment, at least two of the at least two filter element-associated fastening elements can comprise different radial distances in relation to the fastening element center axis around which the fastening elements are arranged. In this way, the arrangement of the at least two filter element-associated fastening elements can be adapted to different conditions. In this context, in case of more than two filter element-associated fastening elements, all fastening elements can comprise different radial distances in relation to the fastening element center axis, or the filter element-associated fastening elements are divided into groups, wherein a first group with filter element-associated fastening elements comprises a first radial distance in relation to the fastening element center axis and a second group with filter element-associated fastening elements comprises a second radial distance in relation to the fastening element center axis. In this context, a plurality of groups with filter element-associated fastening elements at corresponding radial distances in relation to the fastening element center axis are conceivable. In addition, the at least two filter element-associated fastening elements are arranged off-center in relation to the center axis in relation to which the fastening element center axis of the filter element is offset.

According to a beneficial embodiment, at least two of the at least two filter element-associated fastening elements can be arranged at the same radial distance in relation to the fastening element center axis. For example, all filter element-associated fastening elements can comprise the same radial distance in relation to the fastening element center axis. As an alternative, two of the filter element-associated fastening elements can be arranged at the same radial distance in relation to the fastening element center axis and the other filter element-associated fastening elements can comprise radial distances in relation to the fastening element center axis deviating from this radial distance. In addition, a division of the filter element-associated fastening elements into groups is conceivable, wherein the fastening elements of one group are arranged at the same radial distance in relation to the fastening element center axis and the groups differ from each other by the radial distance in relation to the fastening element center axis. In addition, the at least two filter element-associated fastening elements are arranged off-center in relation to the center axis in relation to which the fastening element center axis of the filter element is offset. In embodiments, at least three filter element-associated fastening elements are required in this context.

According to a beneficial embodiment, at least two of the at least two filter element-associated fastening elements can be spaced apart from each other by the same radian or degree measure. For example, all fastening elements can be spaced apart from each other by the same radian or degree measure. In this way, a uniform arrangement of the filter element-associated fastening elements around the fastening element center axis and thereby a uniform force distribution can be provided. Optionally or additionally, a plurality of the filter element-associated fastening elements can be spaced apart from each other by a different radian or degree measure. In this context, the filter element-associated fastening elements can be arranged in an irregular pattern around the fastening element center axis; in this way, the arrangement of the filter element-associated fastening elements can be better adapted to an installation space. Optionally or in addition, at least two of the at least two filter element-associated fastening elements can be arranged with axis symmetry and/or at least two of the at least two filter element-associated fastening elements can be arranged with rotational symmetry in relation to the center axis. Due to a symmetric arrangement of the filter element-associated fastening elements around the center axis, the adaptation of the position of the corresponding housing part-associated fastening elements can be facilitated.

According to a beneficial configuration, the at least two fastening elements can be embodied in a hook shape. In particular, the at least two hook-shaped fastening elements can comprise a hook leg with rectangular or trapezoidal cross section, wherein in particular the base of the hook leg comprises a rectangular or trapezoidal cross section which tapers toward a coupling region. The hook leg passes into the coupling region. The coupling region can comprise at an underside a contact surface which projects away from the hook leg. The coupling region can comprise slanted guide surfaces at a top side. Due to the slanted guide surfaces, the fastening element comprises a narrow upper end region which passes into three slants. The contact surface can be positioned at an approximately right angle in relation to the hook leg. Smaller or larger angles are possible also. In this context, the orientation of the hook elements, in particular the orientation of the coupling region, can also be selected almost freely. For example, the hook elements could face toward the fastening element center axis or away from the fastening element center axes. In addition, each hook element can comprise an orientation different from the other hook elements. The hook elements can interact with housing part-associated complementary hook-shaped fastening elements or with locking openings or locking edges. The hook-shaped elements can be arranged simply at a surface of the end disk which is facing away from the filter medium.

According to a beneficial embodiment, the filter element can comprise a further end disk which is arranged at an end of the filter medium which is facing away from the at least one end disk. In this way, the filter element can comprise two end disks which are arranged at different end regions of the filter medium.

According to a beneficial configuration, the filter element can comprise a center tube which is surrounded by the filter medium. The further center axis, in relation to which the fastening element center axis of the filter element is offset radially, can be preferably the center tube center axis of the center tube. Due to the off-center arrangement of the at least two filter element-associated fastening elements in relation to the center tube center axis, only filter elements constructed for the corresponding filter housing part can be fastened at the filter housing part. In this context, filter housing parts can comprise individually designed filter elements wherein an installation of filter elements not constructed for the corresponding filter housing part can be made difficult or prevented. In this way, the functionality of a corresponding filter arrangement can be improved and the compliance with a quality standard facilitated. Due to the offset of the fastening element center axis of the filter element, around which the at least two filter element-associated fastening elements are arranged, in relation to the center tube center axis, mounting errors such as mounting of a filter element in an unsuitable filter housing part or the insertion with a different orientation than the intended orientation can be avoided or at least made difficult.

According to a beneficial embodiment, at least one guide element can be arranged on at least one of the end disks and/or at a jacket and/or at the center tube. The at least one guide element can be configured for defining a definite angle positioning in relation to the filter housing part at which the filter element can be arranged in a state of use. The filter element can be guided by the guide elements by means of corresponding guide elements of the filter housing part so that the filter element is arranged in the intended state of use and, depending on the guiding action, in a defined orientation at the filter housing part. In this way, joining of the filter element-associated fastening elements and of the housing part-associated fastening elements can be facilitated. Due to the fastening elements, the filter element can be fixed at the filter housing part in this position so that an accidental displacement of the filter element in the filter housing part in operation or during transport or during insertion of the closure element can be avoided. In addition, joining of the filter element-associated fastening elements and of the filter housing part-associated fastening elements can be facilitated by the guide elements.

According to a beneficial embodiment, the at least one guide element can be configured as a radial protrusion or indentation at an outer circumference of the corresponding end disk and/or of the jacket and/or of the center tube. In this way, guide elements can be configured simply at the corresponding element.

According to a further aspect of the invention, a filter housing part for a filter system is proposed, comprising an interior which is configured to at least partially accommodate a filter element, an opening coupled to the interior with at least one opening center axis extending in longitudinal direction, and at least two housing part-associated fastening elements which are arranged concentrically around the same fastening element center axis of the filter housing part extending in longitudinal direction. The fastening element center axis of the filter housing part, around which the housing part-associated fastening elements are concentrically arranged, is arranged radially offset in relation to at least one further filter housing part center axis of the filter housing part extending in longitudinal direction; or offset in relation to at least one filter element center axis of the filter element, which in a state of use can be arranged in the interior, extending in longitudinal direction; or offset in relation to the at least one further filter housing part center axis of the filter housing part extending in longitudinal direction and offset in relation to at least one of the filter element center axes of the filter element extending in longitudinal direction. The at least two housing part-associated fastening elements comprise a different radial distance in relation to the at least one further center axis in relation to which the fastening element center axis of the filter housing part, around which the housing part-associated fastening elements are arranged, is offset. The fastening element center axis of the filter element, around which the at least two filter element-associated fastening elements are concentrically arranged, is arranged in a state of use congruently to the fastening element center axis of the filter housing part around which the at least two housing part-associated fastening elements are concentrically arranged. In this context, the arrangement of the filter element-associated fastening elements at the filter element and of the housing part-associated fastening elements at the filter housing part can be facilitated. In addition, the creation of interacting pairs of filter element-associated fastening elements and housing part-associated fastening elements can be facilitated also in case of an asymmetric arrangement.

The filter housing part can be configured as a filter pot or as a filter cover for a liquid filter, in particular for fuel filter or oil filter.

The opening of the filter housing part can comprise at least two sections extending successively in longitudinal direction, wherein at least one connection section of the opening comprises a connection section center axis extending in longitudinal direction and at least one seal section of the opening comprises a seal section center axis extending in longitudinal direction and at least one seal region. The connection section center axis of the at least one connection section can be arranged offset in relation to the seal section center axis of the at least one seal section. The at least one connection section of the opening can form with a connection segment of a closure element a detachable connection and at least one seal region of a closure segment of the closure element can form with the seal region of the at least one seal section of the opening and with a seal element a seal arrangement. In this context, the fastening element center axis of the filter housing part, around which the at least two housing part-associated fastening elements are arranged, can be offset in relation to the two center axes of the opening or congruently to one of the openings.

In an optional configuration, the opening center axes of the opening can be arranged congruently. In this context, the fastening element center axis of the filter housing part, around which the at least two housing part-associated fastening elements are arranged, can be arranged offset in relation to the congruent opening center axes of the opening. Optionally, the fastening element center axis of the filter housing part, around which the at least two housing part-associated fastening elements are arranged, can be arranged congruently in relation to the congruently arranged opening center axes of the opening and offset in relation to one of the other filter housing part-center axes of the filter housing part and/or offset in relation to at least one of the filter element center axes of the filter element.

In addition, the opening can be arranged off-center in case of a cylinder-shaped embodiment of the filter housing part eccentrically at the filter housing part so that the at least one opening center axis of the opening is arranged offset in relation to a housing wall center axis around which the housing wall of the filter housing part extends. In this context, the fastening element center axis of the filter housing part, around which the at least two housing part-associated fastening elements are arranged, is arranged offset in relation to at least one opening center axis of the opening or offset in relation to the housing wall center axis of the housing wall. In addition, an offset arrangement of the fastening element center axis of the filter housing part, around which the at least two housing part-associated fastening elements are arranged, is possible in relation to one of the filter element center axes of the filter element.

The fastening element center axis of the filter housing part, around which the at least two housing part-associated fastening elements are arranged, forms the center point of at least one circular surface, wherein the at least two housing part-associated fastening elements are arranged on a circumference of the respective circular surface, wherein the distance of the housing part-associated fastening elements in relation to the fastening element center axis is predetermined by the radius of the circular surface. In this context, the at least two housing part-associated fastening elements can be arranged on the circumference of the same circular surface or on the circumference of different circular surfaces around this fastening element center axis, respectively. The arrangement of the at least two housing part-associated fastening elements is substantially only limited in that the housing part-associated fastening elements are arranged off-center in relation to the center axis in relation to which the fastening element center axis, around which the at least two housing part-associated fastening elements are arranged, is offset. In this way, the housing part-associated fastening elements are arranged asymmetrically to at least one filter element center axis of the filter element and/or to at least one filter housing part center axis of the filter housing part. In this context, the at least two housing part-associated fastening elements can be arranged, independent of a geometry of the filter housing, at a housing bottom or at a rim of the opening facing the interior so that a large variety of arrangements of the at least two housing part-associated fastening elements can be achieved. The arrangement of the at least two filter element-associated fastening elements can be adapted in this context, for example, to the installation space of a corresponding filter system.

Since a fastening arrangement comprises at least two fastening element pairs, wherein each fastening element pair comprises a filter element-associated fastening element and a housing part-associated fastening element, respectively, the arrangement of the at least two housing part-associated fastening elements is additionally dependent on the arrangement of the at least two filter element-associated fastening elements because, for the realization of an effective connection, a complementary arrangement of the at least two housing part-associated fastening elements and of the at least two filter element-associated fastening elements is advantageous.

Due to the off-center arrangement of the at least two housing part-associated fastening elements in relation to at least one of the filter element center axes of the filter element and/or in relation to at least one filter housing part center axis of the filter housing part, the at least two housing part-associated fastening elements can be expediently arranged at the housing part even when the filter housing part or one of the elements of the filter housing part is arranged off-center or eccentrically in relation to the filter element arranged in the filter housing part. In addition, it can be effected that only filter elements constructed for the corresponding filter housing part are fastened to the filter housing part. In this way, an installation of filter elements not constructed for the corresponding filter housing part can be made difficult or prevented so that the functionality of a corresponding filter arrangement can be improved and the compliance with a quality standard facilitated. In addition, by means of the filter element-associated fastening elements and the housing part-associated fastening elements, an orientation of the filter element in the filter housing part can be predetermined. A user, by the successful joining of the at least two filter element-associated fastening elements and of the at least two housing part-associated fastening elements, can easily detect whether the correct filter element is arranged at the intended position in the intended orientation in the filter housing part. Due to the offset of the fastening element center axis of the filter housing part, around which the at least two housing part-associated fastening elements are arranged, in relation to one of the filter element center axes of the filter element and/or in relation to a filter housing part center axis of the filter housing part, mounting errors such as mounting of a filter element not intended for the filter housing part in the filter housing part or the insertion in a different orientation than the intended orientation can be avoided or at least made difficult. In addition, due to the fastening arrangement, an insertion depth that is too small or too large of the filter element in the filter housing part can be avoided or at least made difficult.

Due to the fastening element center axis of the filter housing part, around which the at least two housing part-associated fastening elements are arranged, an orientation point for the at least two filter element-associated fastening elements can be provided in addition so that the arrangement of the at least two filter element-associated fastening elements in case of an asymmetric arrangement of the at least two housing part-associated fastening elements at the filter housing part can be facilitated, in particular when the filter element is arranged off-center in the filter housing. In addition, joining of the at least two housing part-associated fastening elements and of the at least two filter element-associated fastening elements can be facilitated.

According to a beneficial embodiment, at least two of the at least two housing part-associated fastening elements can comprise different radial distances in relation to the fastening element center axis of the filter housing part. In this way, the arrangement of the at least two housing part-associated fastening elements can be adapted to different conditions. In this context, in case of more than two housing part-associated fastening elements, all fastening elements can comprise different radial distances in relation to the fastening element center axis of the filter housing part, or the housing part-associated fastening elements are divided into groups, wherein a first group with housing part-associated fastening elements comprises a first radial distance in relation to the fastening element center axis of the filter housing part and a second group with housing part-associated fastening elements comprises a second radial distance in relation to the fastening element center axis of the filter housing part. In this context, a plurality of groups with housing part-associated fastening elements at corresponding radial distances in relation to the center axis are conceivable. In embodiments, at least three housing part-associated fastening elements are required in this context.

According to a beneficial embodiment, at least two of the at least two housing part-associated fastening elements can be arranged at the same radial distance in relation to the fastening element center axis of the filter housing part. For example, all housing part-associated fastening elements can comprise the same radial distance in relation to the fastening element center axis of the filter housing part. Alternatively, two of the housing part-associated fastening elements can be arranged at the same radial distance in relation to the fastening element center axis of the filter housing part and the other housing part-associated fastening elements can comprise radial distances in relation to the fastening element center axis of the filter housing part which deviate from this radial distance. In addition, a division of the housing part-associated fastening elements in groups is conceivable, wherein the fastening elements of a group are arranged at the same radial distance in relation to the center axis and the groups differ from each other by the radial distance in relation to the center axis.

Optionally or in addition, at least two of the at least two housing part-associated fastening elements can be spaced apart from each other at the same radian or degree measure. In this context, a uniform arrangement of the housing part-associated fastening elements around the center axis can be provided.

Optionally or additionally, at least two of the at least two housing-part associated fastening elements can be arranged with axis symmetry and/or at least two of the at least two housing part-associated fastening elements can be arranged with rotational symmetry in relation to the center axis. By a symmetric arrangement of the housing part-associated fastening elements around the center axis, the adaptation of the position of the filter element-associated fastening elements can be facilitated.

Optionally or additionally, a plurality of filter element-associated fastening elements can be spaced apart from each other at a different radian or degree measure. In this context, the filter element-associated fastening elements can be arranged in an irregular pattern around the fastening element center axes so that the arrangement of the filter element-associated fastening elements can be better adapted to an installation space.

According to a beneficial embodiment, the at least two housing part-associated fastening elements can be configured in a hook shape or as an edge with an engagement surface. Hook-shaped fastening elements can be arranged at a bottom or a ceiling or a housing wall of the housing part. Edges with an engagement surface can be arranged at the bottom or at the ceiling or at a wall delimiting the opening and projecting inwardly. Optionally or additionally, edges with engagement surfaces can be formed by projections which project radially inwardly from a housing wall. In particular, the at least two hook-shaped fastening elements can comprise a hook leg with a rectangular or trapezoidal cross section, wherein in particular the base of the hook leg comprises a rectangular or trapezoidal cross section which tapers toward a coupling region. The hook leg passes into the coupling region. The coupling region can comprise at an underside a contact surface which projects away from the hook leg. The coupling region can comprise slanted guide surfaces at a top side. Due to the slanted guide surfaces, the fastening element comprises a narrow upper end region which passes into three slants. The contact surface can be positioned at an approximately right angle in relation to the hook leg. Smaller or larger angles are also possible. In this context, the orientation of the hook elements, in particular the orientation of the coupling region, can also be essentially freely selected. For example, the hook elements can face in the direction of the fastening element center axis or face away from the fastening element center axis. In addition, each hook element can have an orientation which is different from the other hook elements. The hook elements can interact with filter element-associated complementary hook-shaped fastening elements. The contact surfaces of the housing part-associated fastening elements and the contact surfaces of the filter element-associated fastening elements are contacting each other in the state of use.

An edge can be formed by a projection or a protrusion. As an alternative or in addition, an edge can be formed by a fastening opening, wherein the edge surrounds the opening. The engagement surface can correspond to a region of the edge at which the contact surface of the hook element of the filter element rests in the state of use.

According to a beneficial embodiment, at least one guide element can be arranged at at least one housing wall of the filter housing part. In this context, the at least one guide element can guide at least one guide element of the filter element. In particular, the at least one guide element of the filter housing part can be configured for defining a definite angle positioning of the filter element in relation to the filter housing part at which the filter element can be arranged in a state of use. Due to the guiding action of the filter element into a state of use, filter element-associated fastening elements arranged at the filter element and housing part-associated fastening element arranged at the filter housing part can be joined with each other. In this context, the guide elements can be configured such that the filter element can be inserted only in a defined orientation into the filter housing part. For example, a guide element at the filter housing part and a guide element at the filter element can be embodied wider than other guide elements.

According to a beneficial embodiment, the at least one guide element can be configured as a radial protrusion or indentation at an inner circumference of the housing wall. In this way, guide elements can be formed simply at the housing wall, for example, an insertion part with the protrusion or the indentation can rest against the housing wall. As an alternative or in addition, the protrusion or the indentation can be directly provided in the housing wall, for example, punched.

According to a further aspect of the invention, a filter system is proposed with a filter housing part which comprises an interior, an opening coupled to the interior, and at least two housing part-associated fastening elements which are arranged concentrically around a fastening element center axis of the filter housing part. In the interior of the filter housing part, a filter element is arranged in a state of use, wherein the filter element comprises a filter medium and at least one end disk. At least two filter element-associated fastening elements are concentrically arranged around a fastening element center axis of the filter element at the end disk, wherein the filter element in the state of use is detachably fastened at the filter housing part by a fastening arrangement which comprises the at least two filter element-associated fastening elements and the at least two housing part-associated fastening elements interacting therewith. The fastening element center axis of the filter element, around which the at least two filter element-associated fastening elements are concentrically arranged, is arranged offset in relation to at least one further filter element center axis of the filter element and/or offset in relation to at least one filter housing part center axis of the filter housing part. The fastening element center axis of the filter housing part, around which the at least two housing part-associated fastening elements are concentrically arranged, is arranged offset in relation to at least one further filter housing part center axis of the filter housing part and/or offset in relation to at least one filter element center axis of the filter element. In the state of use, the fastening element center axes of the filter element and of the filter housing part around which the corresponding fastening elements are arranged are congruently arranged in relation to each other.

In the state of use, the filter element is advantageously detachably fastened at the filter housing part by the fastening arrangement. The distribution of the filter element-associated fastening elements at the filter element can be limited only by the position of the housing part-associated fastening elements at the filter housing part with which they form a connection. In this context, pairs of filter element-associated fastening elements and housing part-associated fastening elements can be formed. The way the pairs are arranged in relation to each other can be freely selected depending on the installation space or as a function of other factors. Due to the fastening arrangement, the filter element can be held safely in the filter housing part so that in operation or during transport or during insertion of a closure element a displacement of the filter element can be made difficult so that the reliability of the filter system can be improved. In addition, the filter element can be removed together with the filter housing part from another filter housing part.

The opening of the filter housing part can be arranged off-center in case of a cylinder-shaped embodiment of the filter housing part eccentrically at the filter housing part. In this way, at least one opening center axis of the opening can be arranged offset in relation to a filter housing part center axis of the filter housing part. In addition, the opening can be arranged in the direction of gravity at a downwardly position side of the filter housing part or at an upwardly positioned side of the filter housing part.

The filter element can be arranged centrally or off-center in the filter housing part. An opening of the filter element arranged at the end disk can be arranged off-center eccentrically at the filter element in case of a cylinder-shaped embodiment of the filter element. In this way, at least one opening center axis of the opening can be arranged offset in relation to a filter element center axis of the filter element. In addition, the opening can be arranged in the direction of gravity at a downwardly positioned end disk of the filter element or at an upwardly positioned end disk of the filter element.

In the arrangement of the openings can be taken into consideration in case of the freely selectable arrangement of the filter element-associated and of the housing part-associated fastening elements. In addition, the fastening element center axes around which the respective fastening element are arranged form orientation points for the arrangement of the corresponding fastening elements, wherein these orientation points are independent of existing symmetries. In this context, a housing part-associated fastening element and a corresponding filter element-associated fastening element, which form a fastening element pair, comprise the same distance in relation to the corresponding fastening element center axis around which the fastening elements are arranged. In addition, the arrangement of the filter element-associated fastening elements around the corresponding fastening element center axis of the filter element is the same arrangement as the arrangement of the housing part-associated fastening elements around the corresponding fastening element center axis of the filter housing part.

A cross section of the opening of the filter element can be smaller than at least one cross section of the opening of the filter housing part. In this context, an end region of the opening of the filter element, which is facing an end region of the opening of the filter housing part facing the interior, can be arranged above the opening of the filter housing part so that a fluid flowing from the opening of the filter element flows into the opening of the filter housing part. Due to the smaller cross section, the opening of the filter element can act as a funnel. As an alternative, the openings can also be of the same size.

According to a beneficial embodiment, a housing wall of the filter housing part can comprise guide elements guiding guide elements of the filter element, in particular wherein the guide elements of the filter housing part and the guide elements of the filter element are configured for defining a definite angle positioning of the filter element in relation to the filter housing part at which the filter element in a state of use can be arranged, wherein, by the guiding action of the filter element, guide elements arranged at the filter element and guide elements arranged at the filter housing part are joined with each other in a state of use. In this context, the guide elements can be designed such that the filter element can be inserted only in a defined orientation into the filter housing part. For example, a guide element at the filter housing part and a guide element at the filter element can be embodied wider than other guide elements. Due to the guide elements, joining of the filter element-associated and of the housing part-associated fastening elements and thereby fastening of the filter element at the filter housing part can be facilitated.

According to a further aspect of the invention, a use of a filter element in a filter system is proposed, wherein the filter element is inserted into an interior of a filter housing part and is oriented in relation to the filter housing part such that the fastening element center axis of the filter element, around which at least two filter element-associated fastening elements are concentrically arranged, is arranged congruently in relation to a fastening element center axis of the filter housing part around which the at least two housing part-associated fastening elements are concentrically arranged. The at least two filter element-associated fastening elements are oriented in relation to the at least two housing part-associated fastening elements such that the fastening elements form a fastening arrangement for detachable fastening of the filter element at the filter housing part. Due to the fastening arrangement formed of filter element-associated fastening elements and housing part-associated fastening elements, the filter element can be fixed reliably in the filter housing part. This fixation can be released for removal of the filter element.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will expediently consider the features also individually and combine them to expedient further combinations.

FIG. 1 shows a section illustration of a lower region of a first embodiment of a filter system with a filter system, a filter housing part, and a closure element.

FIG. 2 shows a further section illustration of the filter system according to FIG. 1 along the section line II.

FIG. 3 shows a section illustration of a lower region of a second embodiment of a filter system with a filter element, a filter housing part, and a closure element.

FIG. 4 shows a perspective side view of a filter housing part according to an embodiment of the invention.

FIG. 5 shows a section illustration of a third embodiment of a filter system with a filter housing part according to FIG. 4 along the section line VI.

FIG. 6 shows a perspective section illustration of a filter housing part according to an embodiment of the invention.

FIG. 7 shows a perspective view of a filter element according to an embodiment of the invention.

FIG. 8 shows a perspective section illustration of a fourth embodiment of a filter system with a filter housing part according to FIG. 6 and a filter element according to FIG. 7 in an intermediate position and with a closure element.

FIG. 9 shows a perspective section illustration of a filter system according to FIG. 8 in a state of use.

FIG. 10 shows a perspective section illustration of a fifth embodiment of a filter system with a filter housing part according to an embodiment of the invention and a filter element according to an embodiment of the invention in an intermediate position and with a closure element.

FIG. 11 shows a further section illustration of the filter system according to FIG. 10.

FIG. 12 shows a perspective section illustration of a sixth embodiment of a filter system with a filter housing part according to an embodiment of the invention and a filter element according to an embodiment of the invention in an intermediate position and with a closure element.

FIG. 13 shows a perspective section illustration of a seventh embodiment of a filter system with a filter housing part according to an embodiment of the invention and a filter element according to an embodiment of the invention in an intermediate position and with a closure element.

FIG. 14 shows a further section illustration of the filter system according to FIG. 13.

### DETAILED DESCRIPTION

In the Figures, same or same-type components are identified with same reference characters. The Figures show only examples and are not to be understood as limiting.

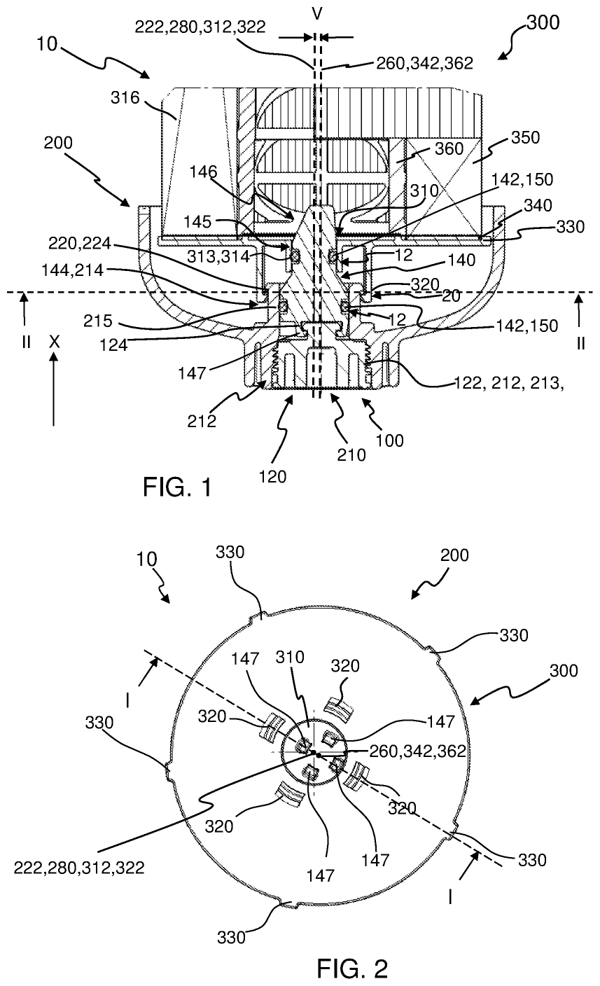

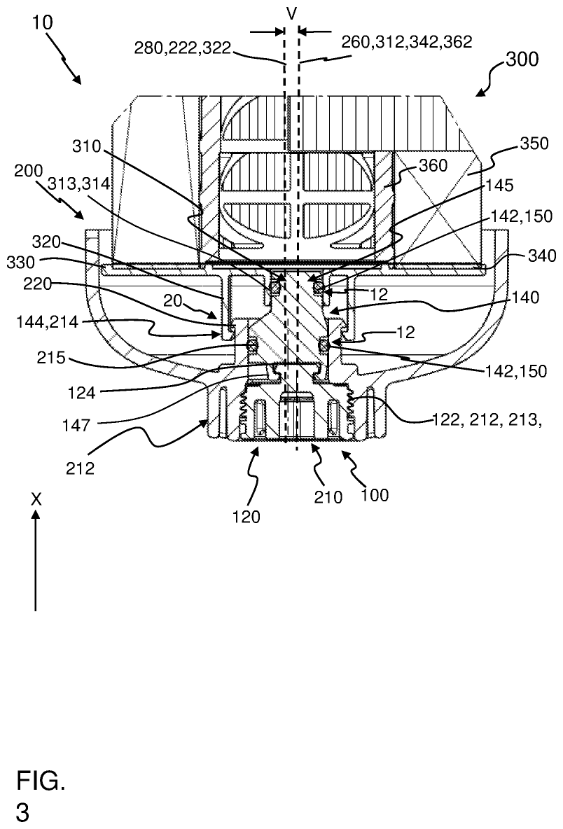

FIG. 1 shows a section illustration of a lower region of a first embodiment of a filter system 10 with the closure element 100, a filter housing part 200, and a filter element 300. FIG. 2 shows a further section illustration of this filter system 10 along the section line II-II with indicated coupling elements 147 of the closure element 100.

FIG. 3 shows a section illustration of a lower region of a second embodiment of a filter system 10 with a closure element 100, a filter housing part 200, and a filter element 300.

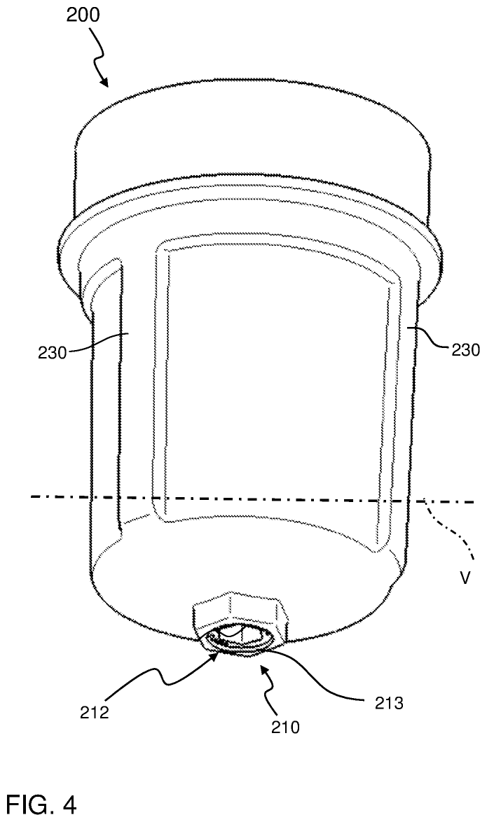

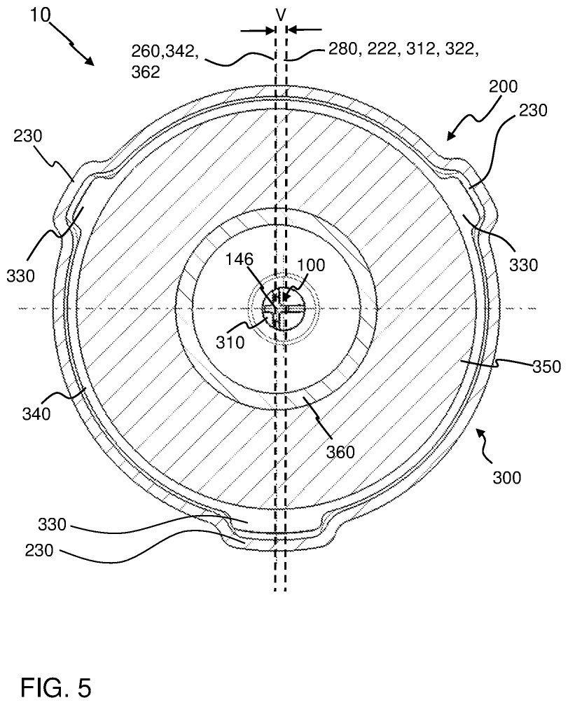

FIG. 4 shows a perspective side view of an embodiment of a filter housing part 200, and FIG. 5 shows a section illustration of a third embodiment of a filter system 10 with such a filter housing part 200, a filter element 300, and a closure element along the section line VI.

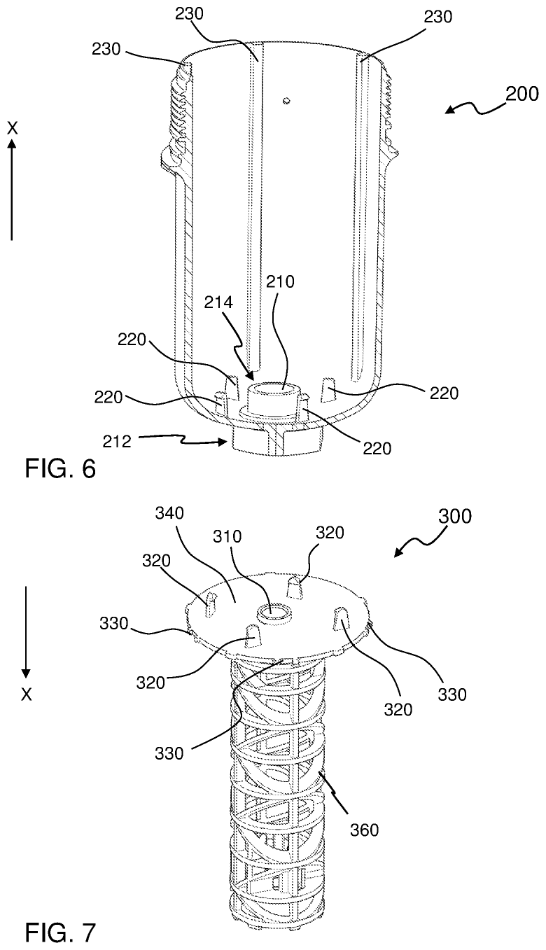

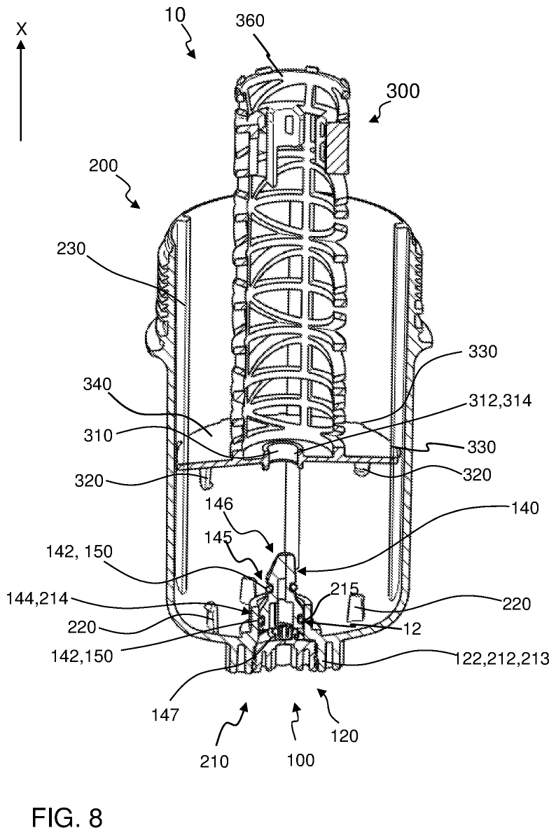

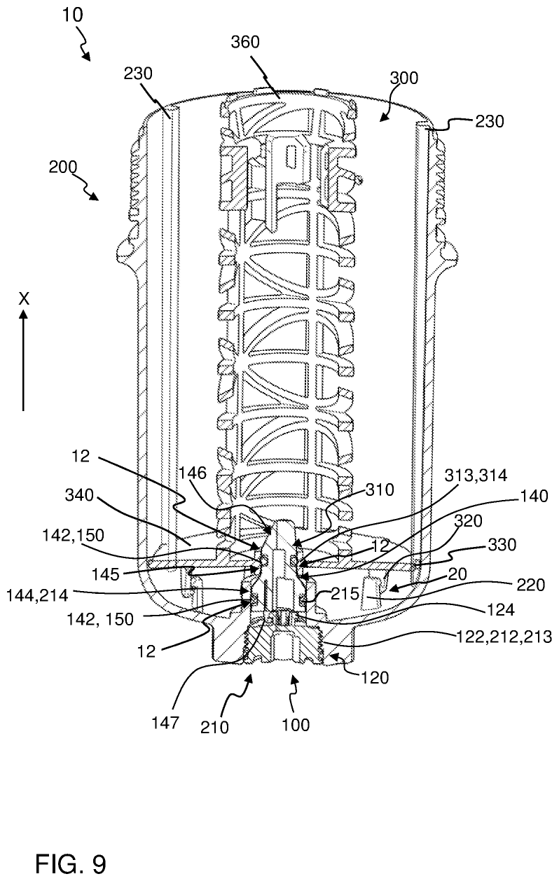

FIG. 6 shows a perspective section illustration of a further embodiment of a filter housing part 200. FIG. 7 shows a perspective view of an embodiment of a filter system 300. FIG. 8 shows a perspective section illustration of a fourth embodiment of a filter system 10 with such a filter housing part 200, such a filter element 300 in an intermediate position, and a closure element 100. FIG. 9 shows the filter system in a state of use.

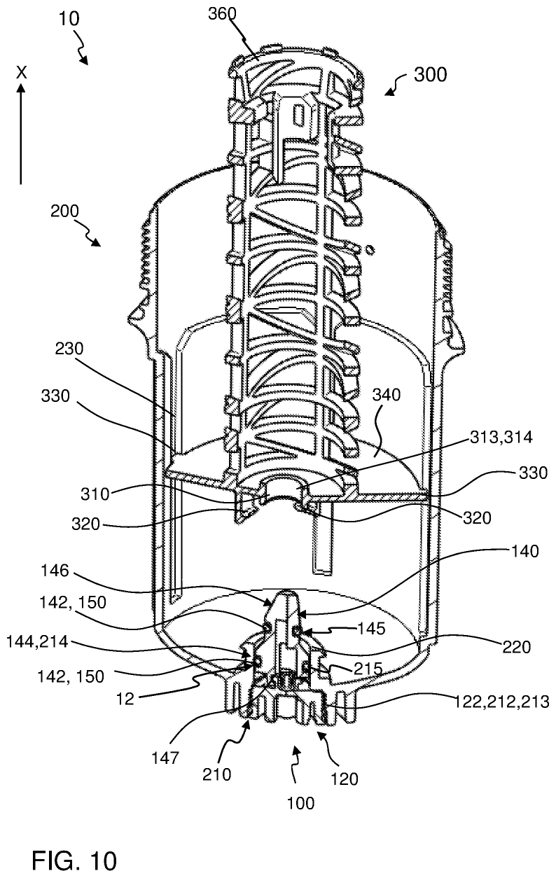

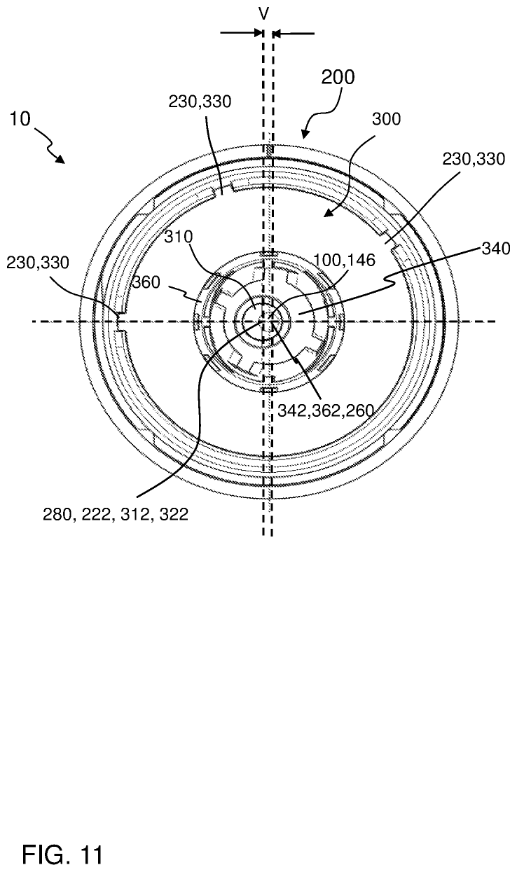

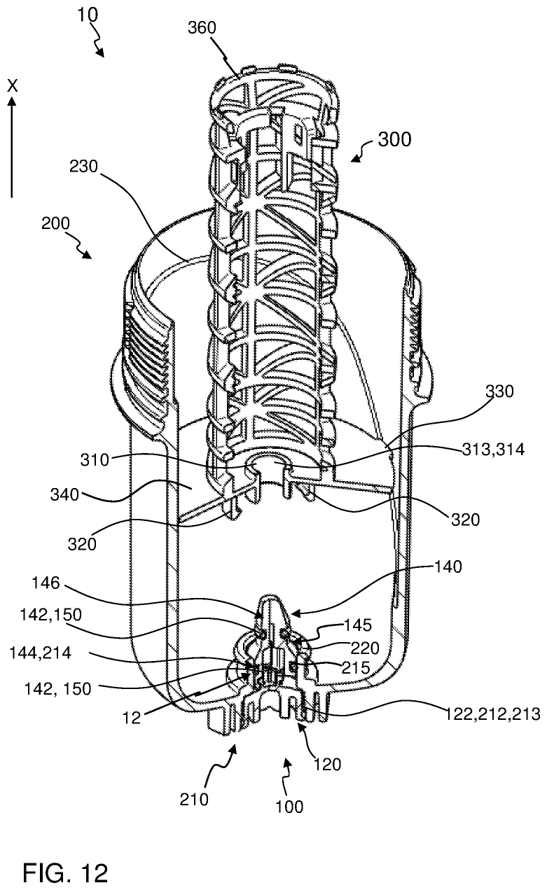

FIG. 10 shows a perspective section illustration of a fifth embodiment of a filter system 10 with a further embodiment of the filter housing part 200, a further embodiment of a filter element 300 in an intermediate position, and an embodiment of the closure element 100. FIG. 11 shows a section illustration of the filter system in the state of use. FIG. 12 shows a perspective section illustration of a sixth embodiment of a filter system 10 with a further embodiment of a filter housing part 200, a further embodiment of a filter element 300 in an intermediate position, and an embodiment of the closure element 100.

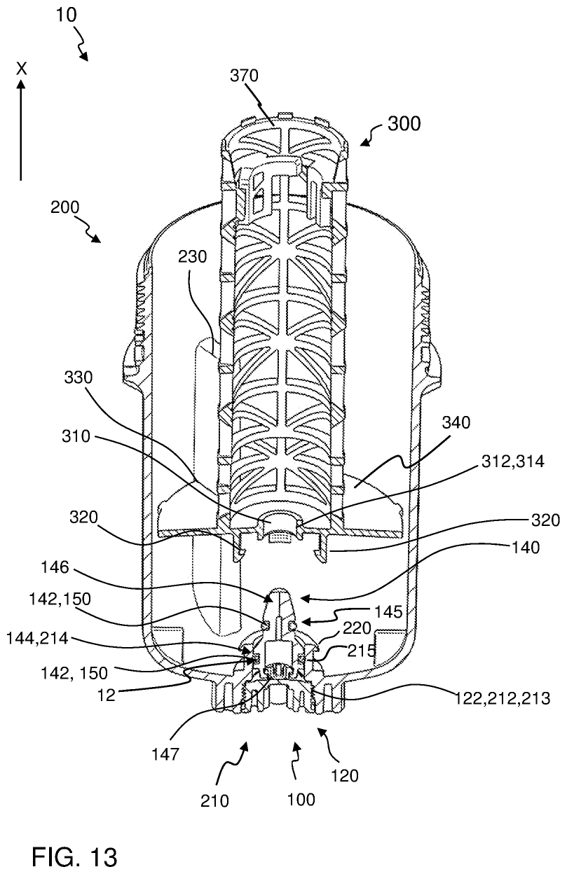

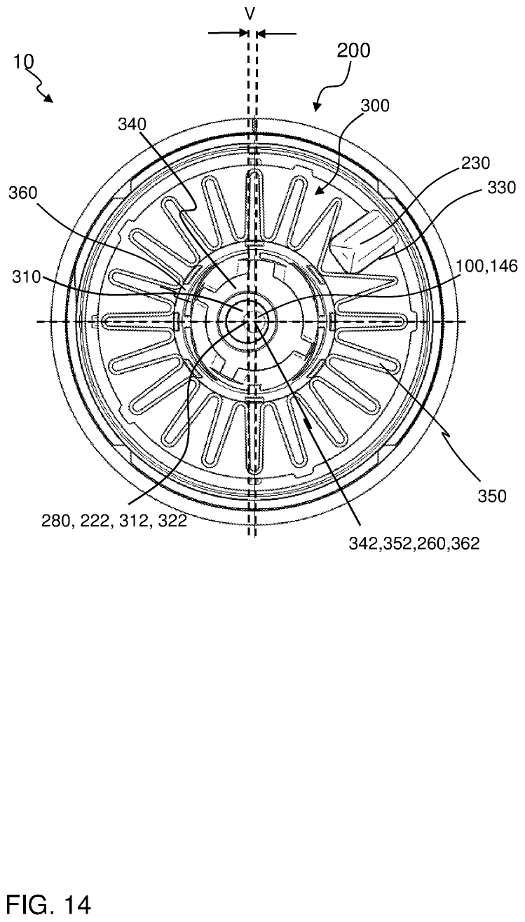

FIG. 13 shows a perspective section illustration of a seventh embodiment of a filter system 10 with a further embodiment of a filter housing part 200, a further embodiment of a filter element 300 in an intermediate position, and an embodiment of the closure element 100. FIG. 14 shows a section illustration of the filter system in the state of use.

In the following, embodiments of a filter system 10 with corresponding embodiments of a filter element 300 and corresponding embodiments of the filter housing part 200 will be described, wherein initially the commonalities and during the further course also the differences will be explained.

As can be seen in FIGS. 1-3, 5, 8, 9-14, the embodiments of the filter system 10 comprise a filter housing part 200 which comprises an interior and an opening 210 coupled to the interior. A closure element 100 closes the opening 210 in at least a first position seal-tightly and releases the opening 210 at least partially in at least one second position, not illustrated. In the second position of the closure element 100, the closure element 100 can release a passage in the opening 210; alternatively, the closure element 100 can be arranged outside of the opening 210, wherein the opening 210 is completely released.

In the interior of the filter housing part 200, a filter element 300 with an opening 310 is arranged. An end region of the opening 310, facing the filter housing part 200, of the filter element 300 is fluidically coupled to the opening 210 of the filter housing part 200. The openings 310, 210 correspond in the illustrated embodiments to drainage openings which are arranged at a filter housing part bottom or at an end disk 340 facing the filter housing part bottom. In an embodiment, not illustrated, the openings 210, 310 can also be inlet openings which are arranged at a filter housing part ceiling and an end disk 340 facing the filter housing part ceiling.

In an embodiment, not illustrated, the filter housing part 200 can comprise a groove in which a corresponding tongue of the filter element 300 engages in the state of use. The groove is arranged so as to extend circumferentially at a housing wall. The tongue can be arranged at a rim region of an end disk 340. This can assist in aligning and fixing the filter element 300 at or in the filter housing part 200. In addition, the filter element 300 can be released simply by a tilting movement from the filter housing part 200. The groove can be arranged at different heights of the filter housing part 200 along the longitudinal direction X.

A further filter housing part, not illustrated, can form together with the illustrated filter housing part 200 a closed filter housing. The additional filter housing part, not illustrated, can comprise a further opening and can be detachably connected to the illustrated filter housing part 200. Due to the two-part filter housing, the filter element 300 arranged in the interior can be easily exchanged as needed. The filter system 10 is embodied as a liquid filter, in particular as a fuel filter or as an oil filter. In this context, the fluid to be filtered flows via the inlet opening into the filter housing, flows through the filter element 300, and the filtered fluid flows through the additional opening of the filter housing part out of the filter housing. In operation, the closure element 100 must be introduced at least into the opening 210 of the filter housing part 200 so that an escape of the fluid from the filter housing part 200 can be prevented. In addition, the closure element 100 can be introduced into the opening 310 of the filter element 300. For emptying the filter housing part 200, the closure element 100 can be brought into a position that releases the opening 210 at least partially.

As can be further seen in FIGS. 1-3, 5, 8, 9-14, the filter element 300 is detachably fastened by a fastening arrangement 20 at the filter housing part 200, wherein the fastening arrangement 20 comprises filter element-associated fastening elements 320 and housing part-associated fastening elements 220 interacting therewith. The distribution of the filter element-associated fastening elements 320 at the filter element 300 is limited only by the position of the fastening elements 220 at the filter housing part 200 and by the orientation of the filter element 300 at the filter housing part 200 or by the formation of pairs of filter element-associated fastening elements 320 and filter housing-associated fastening elements 220. In this context, the filter element 300 and the filter housing part 200 each can comprise two, three, four or more fastening elements 320, 220 which form a corresponding number of fastening element pairs. An arrangement is also conceivable in which the number of the filter element-associated fastening elements 320 differs from the number of the housing part-associated fastening elements 220.

As can be further seen in FIGS. 1-3, 7-10, 12, and 13, the filter element-associated fastening elements 320 are embodied hook-shaped as snap hooks.

In this context, the hook-shaped fastening elements 320 comprise a hook leg with, for example, rectangular or trapezoidal cross section, wherein in particular the base of the hook leg comprises a rectangular or trapezoidal cross section which tapers toward a coupling region. The hook leg passes into the coupling region. The coupling region comprises at an underside a contact surface which projects away from the hook leg. The contact surface in this context is facing the end disk 340 at which the fastening elements 320 are arranged. The coupling region can comprise slanted guide surfaces at a top side. Due to the slanted guide surfaces, the fastening elements 320 comprise a narrow upper end region which passes into three slants. The narrow upper end region of the fastening elements 320 is facing the opening 210 of the filter housing part 200 in the state of use.

The contact surface can be positioned at an approximately right angle in relation to the hook leg. Other smaller or larger angles are also possible.

The embodiments of the filter housing part 200 illustrated in FIGS. 1, 3, 10, 12, 13 comprise housing part-associated fastening elements 220 which are embodied as an edge with an engagement surface.

In the illustrated embodiments of the filter housing part 200, the opening 210 comprises at an end region facing the interior a continuously circumferentially extending collar which forms the edges with the engagement surface at which the filter element-associated snap hooks engage. In an alternative embodiment, not illustrated, the housing wall can comprise at least one projection radially projecting into the interior which forms the edges with the engagement surface at which the filter element-associated snap hooks engage. The engagement surface is arranged at the side of the projection or of the collar which is facing away from the end disk 340.

The embodiments of the filter housing part 200 illustrated in FIGS. 6, 8, and 9 comprise housing part-associated fastening elements 220 which are formed as snap hooks. In the illustrated embodiments of the filter housing part 200, these snap hooks are distributed at the housing part bottom. The housing part-associated fastening elements 220 are embodied in the illustrated embodiments like the filter element-associated fastening elements 320. Only the orientation of the housing-associated fastening elements 220 differs from the orientation of the filter element-associated fastening elements 320. In an alternative embodiment, the shapes of the housing part-associated fastening elements 220 and of the filter element-associated fastening elements 320 can differ.

The filter element-associated snap hooks interact paired with housing part-associated snap hooks or with housing part-associated engagement surfaces and form in this way the fastening arrangement 20. In this context, the contact surfaces of the fastening elements 220, 320 of a fastening element pair or the contact surface and the engagement surface of a fastening element pair in the state of use are resting on each other and make difficult a movement of the filter element 300 in longitudinal direction x.

In an alternative embodiment, not illustrated, the filter element 300 can comprise the collar and the filter housing part 200 the snap hooks. In addition, other suitable fastening elements 220, 320 are conceivable. In addition, a combination of pairs with snap hooks and of pairs with snap hooks and engagement surfaces are conceivable. Furthermore, the engagement surfaces can be arranged around engagement openings in which a snap hook can engage.

As can be further seen in FIGS. 1, 3, 5, 7, 8-14, the filter element 300 comprises a center tube 360 which supports a filter medium 350 from the interior and at least one end disk 340, wherein the at least one end disk 340 comprises the opening 310 with at least one opening center axis 312 and at least one seal region 314. In an alternative embodiment, not illustrated, the filter element 300 can additionally or alternatively comprise a jacket which at least partially surrounds the filter medium 350 externally.

As can be further seen in FIGS. 1, 3, 5, 7-14, the end disk 340, the opening 310 of the end disk 340, and the center tube 360 are arranged with rotational symmetry around a corresponding center axis, namely end disk center axis 342, center tube center axis 362, opening center axis 312, which extends through the center point of the respective cross section.

As can be seen in FIGS. 1, 3, 4, 6, 8-10, 12, and 13, the filter housing part 200 for the filter system 10 comprises the interior and the opening 210 coupled to the interior. The opening 210 is arranged in longitudinal direction X at the bottom at the filter housing part 200 so that the fluid upon releasing the opening 210 can flow out of the interior, driven by the force of gravity. The opening 210 comprises two sections 212, 214 arranged successively in longitudinal direction X. A connection section 212 comprises a connection section center axis 260 extending in longitudinal direction X. A seal section 214 comprises a seal section center axis 280 extending in longitudinal direction X and a seal region 215. The connection section center axis 260 of the connection section 212 is arranged offset in relation to the seal section center axis 280 of the seal section 214. Here, the axis offset v of the two center axes 260, 280 of the opening 210 corresponds to the axis offset v of a corresponding closure element 100 which is insertable into the opening 210 and closes seal-tightly the opening 210 in at least one first position. In an alternative embodiment, not illustrated, the seal section center axis 280 of the seal section 214 and the connection section center axis 260 of the connection section 212 can be arranged congruently to each other.

A closure element 100 is understood as a component which is insertable into at least one opening 210, 310 of the filter system 10 and, in the inserted state, closes it seal-tightly in at least one first position. In this context, the closure element 100 is detachably connected to the at least one opening 210, 310. The closure element 100 comprises a connection segment 120 and a closure segment 140.

A closure segment 140 is understood as a segment which can seal-tightly close at least one of the openings 210, 310 of the filter system 10 in the at least one first position of the closure element 100. For this purpose, a seal element 150 or seal elements 150 can be arranged between a corresponding seal region 142 of the closure segment 140 and seal region 215, 314 of a seal section 214, 313 of the opening 210, 310 and form a seal arrangement 12.

A connection segment 120 is understood as a segment which can be detachably connected to a connection section 212 of the opening 210. In this context, a first section 144 projects into the seal section 214 of the opening 210. When one of the embodiments of the closure element 100 with a second section 145, or a second section 145 and a third section 146, is arranged in the opening 210, the second section 145, or the second section 145 and the third section 146, project then in the at least one first position at least partially into the interior of the filter housing part 200. In this context, the sections 145, 146 can project into an opening 310 of the filter element 300 which projects into the interior.

As can be further seen in FIGS. 1-3, 5-14, a cross section of the opening 310 of the filter element 300 is smaller or equal to the cross section of the seal section 214 or the cross section of the end region of the seal section 214 of the opening 210 of the filter housing part 200 facing the interior. In this context, the opening 310 of the filter element 300 can act as a funnel and can guide the fluid into the opening 210 of the filter housing part 200.

As can be further seen in FIGS. 1-3, 5, 7-14, the illustrated embodiments of the filter element 300 comprise the end disk 340 at which at least two filter element-associated fastening elements 320 are arranged. The at least two filter element-associated fastening elements 320 are arranged concentrically around the same fastening element center axis 322 of the filter element 300 extending in longitudinal direction X. This fastening element center axis 322 of the filter element 300 is arranged offset in relation to at least one further filter element center axis 312, 342, 362 of the filter element 300 extending in longitudinal direction X, or offset in relation to at least one filter housing part center axis 260, 280, extending in longitudinal direction X, of the filter housing part 200 at which the filter element 300 is arranged in the state of use. Alternatively, the fastening element center axis 322 of the filter element 300, around which the at least two filter element-associated fastening elements 320 are concentrically arranged, can be arranged offset in relation to at least one of the further filter element center axes 312, 342, 362 of the filter element 300 extending in longitudinal direction X and offset in relation to at least one filter housing part center axis 260, 280 of the filter housing part 200 extending in longitudinal direction X. The at least two filter element-associated fastening elements 320 comprise a different radial distance in relation to the at least one of the center axes 312, 342, 362, 260, 280 in relation to which the fastening element center axis 322 of the filter element 300, around which the filter element-associated fastening elements 320 are arranged, is offset.

As can be further seen in FIG. 14, the filter medium 350 in the illustrated embodiment is pleated to an in particular star-shaped folded bellows, in particular wherein preferably the further center axis 312, 342, 352, 362, 260, 280, in relation to which the fastening element center axis 322 of the filter element 300 is offset, is a folded bellows center axis 352 of the folded bellows. In this context, the Acentral center axis@ of the filter element 300 can be defined by the folded bellows center axis 352 of the folded bellows because the latter preferably can be embodied with identical fold heights in circumferential direction.

As can be seen further in FIGS. 1-3, 5, 7-14, the end disk 340 comprises an opening 310 with at least one opening center axis 312 extending in longitudinal direction X. The opening 310 can be arranged centrally or off-center at the end disk 340.

As can be further seen in FIG. 3, in the illustrated embodiment the further center axes 312, 342, 362, 260, 280, in relation to which the fastening element center axis 322 of the filter element 300 is radially offset, is the opening center axis 312 of the opening 310. Optionally, three, four or more filter element-associated fastening elements can be present.

As can be further seen in FIGS. 1, 3, 6, 8-10, 12, and 13, the filter housing part 200 for the filter system 10 comprises at least two housing part-associated fastening elements 220 which are arranged concentrically around the same fastening element center axis 222 of the filter housing part 200 extending in longitudinal direction X. The fastening element center axis 222 is arranged offset in relation to at least one filter housing part center axis 260, 280 of the filter housing part 200 extending in longitudinal direction X, or offset in relation to at least one filter element center axis 312, 342, 362, extending in longitudinal direction X, of the filter element 300 which is arranged in the interior in a state of use. As an alternative, the fastening element center axis 222 of the filter housing part 200, around which the housing part-associated fastening elements 220 are concentrically arranged, is arranged offset in relation to at least one of the further filter housing part center axis 260, 280 of the filter housing part 200 extending in longitudinal direction X and offset in relation to at least one of the filter element center axes 312, 342, 362 of the filter element 300 extending in longitudinal direction X. The at least two housing part-associated fastening elements 220 comprise a different radial distance in relation to the at least one center axis 312, 342, 362, 260, 280 in relation to which the fastening element pair center axis 222 of the filter housing part 200, around which the housing part-associated fastening elements 220 are arranged, is offset. The fastening element center axis 322 of the filter element 300, around which the at least two filter element-associated fastening elements 320 are concentrically arranged, is arranged congruently in the state of use in relation to the fastening element center axis 222 of the filter housing part 200, around which the at least two housing part-associated fastening elements 220 are concentrically arranged.

The first embodiment of the filter arrangement illustrated in FIGS. 1 and 2 comprises an embodiment of the filter element 300 in which the opening 310 of the filter element 300 is arranged slightly offset at the end disk 340. In this context, the opening center axis 312 of the opening 310 is arranged offset in relation to the end disk center axis 342 of the end disk 340. The center tube 360 is arranged centrally at the end disk 340, wherein the center tube center axis 362 of the center tube 360 and the end disk center axis 342 of the end disk 340 are arranged congruently to each other. In this way, the center tube 360 and the opening 310 are also arranged offset to each other.

As can be further seen in FIG. 1, the filter element 300 is arranged centrally in the interior of the filter housing part 200. In an alternative embodiment, not illustrated, the center axes 362, 312 of the center tube 360 and of the opening 310 can also be congruently arranged to each other. In addition, an offset arrangement of the center axes 362, 312, 342 of the center tube 360, of the opening 310, and of the end disk 340 is conceivable, wherein the opening 310 and the center tube 360 are not centrally arranged at the end disk 340. The fastening element center axis 322 of the filter element 300, around which the at least two filter element-associated fastening elements 320 are concentrically arranged, is congruently arranged in relation to the opening center axis 312 and offset in relation to the end disk center axis 342 and offset in relation to the center tube center axis 362 in the illustrated embodiment. The filter element-associated fastening element 320 comprises in the illustrated embodiment the same radial distance in relation to the fastening element center axis 322 of the filter element 300 and therefore the same distance in relation to the rim of the opening 310. The filter element-associated fastening elements 320 comprise a different radial distance in relation to the center point of the center tube 360 and in relation to the center point of the end disk 340. In this context, in the illustrated embodiment the distance between the right filter element-associated fastening element 320 and the end disk center axis 342 of the end disk 340 is smaller than the distance between the left filter element-associated fastening element and end disk center axis 342 of the end disk 340. In an alternative embodiment, not illustrated, the fastening element center axis 322 of the filter element 300, around which the at least two filter element-associated fastening elements 320 are concentrically arranged, can also be offset in relation to the opening center axis 312. In addition, a congruent arrangement in relation to the end disk center axis 342 and/or to the center tube center axis 362 is possible.

As can be further seen in FIGS. 1 and 2, the fastening element center axis 322 of the filter element 300, around which the at least two filter element-associated fastening elements 320 are concentrically arranged, is arranged offset in relation to the connection section center axis 260 of the connection section 212 of the opening 210 of the filter housing 200. The fastening element center axis 322 of the filter element 300, around which the at least two filter element-associated fastening elements 320 are concentrically arranged, is congruently arranged in relation to the seal section center axis 280 of the seal section 214 of the opening 210 of the filter housing part 200.

Since the fastening element center axis 222 of the filter housing part 200, around which the at least two housing part-associated fastening elements 220 are concentrically arranged, is arranged congruently to the fastening element center axis 322 of the filter element 300, around which the at least two filter element-associated fastening elements 320 are concentrically arranged, the fastening element center axis 222 of the filter housing part 200, around which the at least two housing part-associated fastening elements 220 are concentrically arranged, comprises the same axis offset v to the other center axes 260, 280, 312, 342, 362 of the filter system 10 as the fastening element center axis 322 of the filter element 300, around which the at least two filter element-associated fastening elements 320 are concentrically arranged.

As can be further seen in FIGS. 1 and 2, the filter element-associated fastening elements 320 are arranged at the same radial distance in relation to the fastening element center axes 322 of the filter element 300. In addition, the filter element-associated fastening elements 320 are spaced apart from each other at the same radian and degree measure. Furthermore, the filter element-associated fastening elements 320 are arranged with axis symmetry and rotational symmetry in relation to the fastening element center axis 322 of the filter element 300. The filter element-associated fastening elements 320 project from the end disk 340 into a free space between the end disk 340 and the housing bottom.

As can be further seen in FIGS. 1 and 2, the opening 210 of the illustrated embodiment of the filter housing part 200 comprises an end region projecting into the free space between the end disk 340 and the housing bottom and comprising the collar. The collar and the end region have a round cross section which extends around the seal section center axis 280 of the seal section 214. In this way, the edges arranged at the collar with engagement surfaces embodied as fastening element 220 at the underside of the collar are arranged at the same radial distance in relation to the fastening element center axis 222 of the filter housing part 200. In addition, the housing part-associated fastening elements 220 are spaced apart from each other at the same radian and degree measure. In addition, housing part-associated fastening elements 222 are arranged with axis symmetry and rotational symmetry in relation to the fastening element center axis 222 of the filter housing part 200.

As can be further seen in FIGS. 1 and 2, the filter element-associated fastening elements 320 are embodied in a hook shape. The hook tips extend radially from the exterior to the interior, respectively. The locking hooks engage the engagement surfaces in the state of use.

As can be further seen in FIG. 2, the filter element-associated fastening elements 320 and the housing part-associated fastening elements 220 are arranged offset in relation to coupling elements 147, 124 of the closure element 100 projecting into the openings 210, 310.

As can be further seen in FIG. 2, the illustrated filter element 300 comprises five guide elements 330 projecting away from the rim of the end disk 340 which can be guided in corresponding guide elements 230 of the filter housing part which are formed as radial indentations at an inner circumference of a housing wall. As an alternative, an embodiment as a radial protrusion is also conceivable. Also, a different number of guide elements 230, 330 is conceivable. By means of the guide elements 230, 330, the filter element 300 can be guided into the state of use and fastening elements 320 arranged at the filter element 300 and fastening elements 220 arranged at the filter housing part 200 can be joined with each other and the opening 310 of the filter element 300 can be fluidically coupled to the opening 210 of the filter housing part 200. In addition, the orientation of the opening 310 of the filter element 300 in relation to a second section 145 of the closure element 100 can be realized by the guiding action. In addition, due to the guide elements 230 of the filter housing part 200 and the guide elements 330 of the filter element 300, a definition of a definite angle positioning of the filter element 300 in relation to the filter housing part 200, at which the filter element 300 can be arranged in a state of use, is possible.

The second embodiment of the filter arrangement 10 illustrated in FIG. 3 differs from the first embodiment of the filter arrangement 10 illustrated in FIGS. 1 and 2 substantially in that the opening 310 of the filter element is arranged eccentrically in relation to the seal section 214 of the opening 210 of the filter housing part 200 facing the interior. In this context, the opening center axis 312 of the opening 310 is arranged offset in relation to the seal section center axis 280 of the seal section 214.

As can be further seen in FIG. 3, the filter element 300 is arranged centrally in the interior of the filter housing part 200.

As can be further seen in FIG. 3, in the illustrated embodiment of the filter element 300, the center tube 360 and opening 310 are arranged centrally at the end disk 340. The center axes 362, 312 of the center tube 360 and of the opening 310 are congruently arranged in relation to each other and congruently to the end disk center axis 342 of the end disk 340. The fastening element center axis 322 of the filter element 300, around which the at least two filter element-associated fastening elements 320 are concentrically arranged, is arranged offset in relation to the center axes 362, 342, 312 of the center tube 360, of the end disk 340, and of the opening 310 in the illustrated embodiment. In this context, in the illustrated embodiment the distance between the right filter element-associated fastening element 320 and the congruent center axes 362, 342, 312 of the center tube 360, of the end disk 340, and of the opening 310 is smaller than the distance between the left filter element-associated fastening element 320 and the congruent center axes 362, 342, 312 of the center tube 360, of the end disk 340, and the opening 310.

As can be further seen in FIG. 3, the fastening element center axis 322 of the filter element 300, around which the at least two filter element-associated fastening elements 320 are concentrically arranged, is arranged offset in relation to the connection section center axis 260 of the connection section 212 of the opening 210 of the filter housing part 200. The fastening element center axis 322 of the filter element 300, around which the at least two filter element-associated fastening elements 320 are concentrically arranged, is arranged congruently in relation to the seal section center axis 280 of the seal section 214 of the opening 210 of the filter housing part 200.

Since the fastening element center axis 222 of the filter housing part 200, around which the at least two housing part-associated fastening elements 220 are concentrically arranged, is arranged congruently in relation to the fastening element center axis 322 of the filter element 300, around which the at least two filter element-associated fastening elements 320 are concentrically arranged, the fastening element center axis 222 of the filter housing part 200 comprises the same axis offset v in relation to the other center axes 260, 280, 312, 342, 362 of the filter system 10 as the fastening element center axis 322 of the filter element 300.

In FIG. 4, an exterior view of an embodiment of the filter housing part 200 is illustrated which shows guide elements 230 from the exterior. In addition, the opening 210 is released. The connection section 212 of the opening 210 comprises in the illustrated embodiment a connection element 213 embodied as an inner thread which can form a detachable connection with a connection element 122 embodied as an outer thread (FIGS. 1, 3, 8-12, 13) of the connection segment 120 of the closure element 100.

FIG. 5 shows a section illustration of the third embodiment of the filter system 10 along the section line VI of FIG. 4. In this context, in the filter housing part 200 a filter element 300 is arranged. A closure element 100 is arranged in the openings 210, 310. The filter element 300 comprises guide elements 330 which project radially outwardly from a rim of the end disk 340. These guide elements 330 are guided by the guide elements 230 of the filter housing part 200. In addition, due to the guide elements 230 of the filter housing part 200 and the guide elements 330 of the filter element 300, a definition of a definite angle positioning of the filter element 300 in relation to the filter housing part 200, at which the filter element 300 can be arranged in a state of use, is possible.

The third embodiment of the filter arrangement illustrated in FIG. 5 comprises also the filter element 300 that is centrally arranged in the filter housing. In addition, in the illustrated embodiment of the filter element 300, the center tube 360 is centrally arranged at the end disk 340. The center axes 342, 362 of the end disk 340 and of the center tube 360 are congruently arranged in relation to each other.

As can be further seen in FIG. 5, the opening 310 is arranged eccentrically in relation to the center tube 360 and in relation to the end disk 340. In this context, the opening center axis 312 of the opening 310 is offset in relation to the center axes 342, 362 of the end disk 340 and of the center tube 360.

The fastening element center axis 322 of the filter element 300, around which the at least two filter element-associated fastening elements 320, not illustrated, are concentrically arranged, is arranged offset in the illustrated embodiment in relation to the center axes 362, 342 of the center tube 360 and of the end disk 340. The fastening element center axis 322 of the filter element 300, around which the at least two filter element-associated fastening elements 320, not illustrated, are concentrically arranged, is arranged in addition offset in relation to the connection section center axis 260 of the connection section 212 of the opening 210 of the filter housing part 200. The fastening element center axis 322 of the filter element 300, around which the at least two filter element-associated fastening elements 320, not illustrated, are concentrically arranged, is congruently arranged in relation to the seal section center axis 280 of the seal section 214 of the opening 210 of the filter housing part 200 and congruently in relation to the opening center axis 312 of the opening 310 of the filter element 300. The opening 310 of the filter element 300 is arranged coaxially in relation to the seal section 214 of the opening 210 of the filter housing part 200. In this way, the fastening element center axis 322 of the filter element 300, around which the at least two filter element-associated fastening elements 320 are concentrically arranged, is congruently arranged to the seal section center axis 280 of the seal section 214 of the opening 210 of the filter housing part 200. Other arrangements are also conceivable.

Since the fastening element center axis 222 of the filter housing part 200, around which the at least two housing part-associated fastening elements 220 are concentrically arranged, is congruently arranged in relation to the fastening element center axis 322 of the filter element 300, around which the at least two filter element-associated fastening elements 320 are concentrically arranged, the fastening element center axis 222 of the filter housing part 200, around which the at least two housing part-associated fastening elements 220 are concentrically arranged, comprises the same axis offset v in relation to the other center axes 260, 280, 312, 342, 362 of the filter system 10 as the fastening element center axis 322 of the filter element 300, around which the at least two filter element-associated fastening elements 320 are concentrically arranged.

As can be seen in FIG. 5, a guide element 330 of the filter element 300 is embodied wider than the two other guide elements 330. The filter housing part 200 comprises a corresponding wide guide element 230 and two narrower guide elements 230 so that the orientation of the filter element 300 in the filter housing part 200 and the orientation of the opening 310 of the filter element 300 in relation to the opening 210 of the filter housing part 200 or the orientation of the filter element-associated fastening element 320 in relation to the housing part-associated fastening elements 220 can be predetermined. Other guide elements 230, 330 and other arrangements are also conceivable. By means of the guide elements 230, 330, it can be ensured that the fastening element center axis 322 of the filter element 300, around which the at least two filter element-associated fastening elements 320 are arranged, is congruent in relation to the fastening element center axis 222 of the filter housing part 200, around which the at least two housing part-associated fastening elements 220 are concentrically arranged.

The fourth embodiment of the filter arrangement 10 illustrated in FIGS. 6 to 9 differs from the embodiments of the filter arrangement 10 illustrated in FIGS. 1 through 5 substantially in that the housing part-associated fastening elements 220 are also embodied in a hook shape. The hook-shaped housing part-associated fastening elements 220 in the illustrated embodiment are arranged at a bottom of the filter housing part 200 and project into a free space between the end disk 340 of the filter element and the bottom. In this way, fastening element center axis 222 of the filter housing part 200, around which the housing part-associated fastening elements 220 are arranged, can be arranged offset in relation to a seal section center axis 280 of the seal sections 214 of the opening 210 of the filter housing part 200 because the arrangement of the housing part-associated fastening elements 220 is independent of a collar of the seal section 214 projecting into the interior.

As can be further seen in FIGS. 6 to 9, the hook-shaped fastening elements 220, 320 are differently oriented. In an alternative embodiment, not illustrated, the hook tips each can extend radially from the exterior to the interior or from the interior to the exterior or axially in the same direction. In the illustrated embodiment, the hook tips of the housing part-associated fastening elements 220 are oriented from the interior to the exterior, the hook tips of the filter element-associated fastening elements 320 are oriented from the exterior to the interior.

As can be further seen in FIGS. 7 to 9, guide elements 330 of the filter element 300 are embodied as a groove which is provided in elements which are radially projecting away from a rim of the end disk 340.

As can be further seen in FIGS. 6, 8, and 9, the guide elements 230 of the filter housing part 200 are embodied as guide rails which are projecting away from a housing wall radially inwardly and extend in longitudinal direction X.

Other guide elements 230, 330 are also conceivable. In addition, different arrangements of the fastening elements 220, 320 can be combined with different embodiments of the guide elements 230, 330.

As is further disclosed in FIGS. 10 and 11, the guide elements 330 of the filter element 300 of the fifth embodiment of the filter system 10 are embodied as bulges which are projecting outwardly away from a rim of the end disk 340 in radial direction. These guide elements 330 are guided by the guide elements 230 of the filter housing part 200. In this context, the guide elements 230 of the filter housing part 200 are embodied as cutouts in which a corresponding guide element 330 of the filter element 300 designed as a bulge is guided. In contrast to the embodiment illustrated in FIG. 5, the cutout is not punched into the housing wall but is formed at the interior and is realized by an additional component inserted into the interior. The filter housing part 200 comprises a plurality of such guide elements 230.

The fastening element center axes 222, 322, around which the fastening elements 220, 320 of the fastening arrangement 20 are arranged, are congruently arranged in relation to the seal section center axis 280 of the seal section 214 of the opening 210 of the filter housing part 200.

As can be further seen in FIG. 11, the fastening element center axes 222, 322, around which the fastening elements 220, 320 are arranged, are arranged in addition congruently in relation to the opening center axis 312 of the opening 310 of the filter element 300.

As can be further seen in FIG. 11, the fastening element center axis 222, 322 around which the fastening elements 220, 320 are arranged, are arranged offset in relation to the connection section center axis 260 of the connection section 212 and offset in relation to the center tube center axis 362 of the center tube 360.

The sixth embodiment of the filter system 10 illustrated in FIG. 12 and the seventh embodiment of the filter system 10 illustrated in FIGS. 13 and 14 differ from the fifth embodiment of the filter system illustrated in FIGS. 10 and 11 only in the configuration of the guide elements 230, 330 at the filter housing part 200 and at the filter element 300.

In FIG. 12, the guide element 230 is embodied as a conical axial edge on which a guide element 330 of the filter element 300 designed as a bulge is guided.

In FIGS. 13 and 14, the filter housing part 200 comprises a large inwardly projecting guide element 230 which is guided in a groove in the end disk 340. In this context, the filter medium 350 embodied as a folded bellows is provided in the region of the groove with a larger fold distance.

In the illustrated embodiments, the filter element-associated fastening elements 320 and the housing part-associated fastening elements 220 are spaced apart from each other in a regular pattern around the corresponding fastening element center axis 222, 322 at the same radian and degree measure. In an alternative embodiment, filter element-associated fastening elements 320 and the housing part-associated fastening elements 220 can also be arranged in an irregular pattern around the corresponding fastening element center axis 222, 322.

The fastening arrangement 20 can fix the filter element 300 at a filter housing part 200 embodied as a filter pot as well as at a filter housing part 200 embodied as an end cap. The filter element 300 in case of a fixation at an end cap can be simply lifted together with the end cap from the filter pot and removed from the filter pot.

In a use of the filter element 300 in a filter system 10, not illustrated in detail, the filter element 300 is inserted into an interior of the filter housing part 200 and is oriented in relation to the filter housing part 200 such that the fastening element center axis 322 of the filter element 300, around which at least two filter element-associated fastening elements 320 are concentrically arranged, is arranged congruently in relation to a fastening element center axis 222 of the filter housing part 200, around which the at least two housing part-associated fastening elements 320 are concentrically arranged. The at least two filter element-associated fastening elements 320 are oriented in such a way to the at least two housing part-associated fastening elements 220 that the fastening elements 220, 320 form a fastening arrangement 20 for detachable fastening of the filter element 300 at the filter housing part 200.

1. A filter element for a filter system, the filter element comprising:
a filter medium;
one or more end disks; and
two or more filter element-associated fastening elements arranged at the one or more end disks, wherein the two or more filter element-associated fastening elements are arranged concentrically around a fastening element center axis of the filter element extending in a longitudinal direction, and the fastening element center axis of the filter element is radially offset in relation to at least one further center axis,
wherein the at least one further center axis comprises at least one filter element center axis of the filter element extending in the longitudinal direction, or the at least one further center axis comprises at least one filter housing part center axis of a filter housing part at which the filter element is arranged in a state of use, wherein the at least one filter housing part center axis extends in the longitudinal direction, or the at least one further center axis comprises at least one filter element center axis of the filter element extending in the longitudinal direction and at least one filter housing part center axis of a filter housing part at which the filter element is arranged in a state of use, wherein the at least one filter housing part center axis extends in the longitudinal direction, and
wherein the two or more filter element-associated fastening elements comprise a different radial distance in relation to the at least one further center axis, in relation to which the fastening element center axis of the filter element is offset.

2. The filter element according to claim 1, wherein the filter medium is pleated to a folded bellows, and
the at least one further center axis, in relation to which the fastening element center axis of the filter element is radially offset, comprises a folded bellows center axis of the folded bellows.

3. The filter element according to claim 1, wherein one of the end disks comprises an opening with at least one opening center axis extending in the longitudinal direction, and
the at least one further center axis, in relation to which the fastening element center axis of the filter element is radially offset, comprises the at least one opening center axis of the opening.

4. The filter element according to claim 1, wherein the two or more filter element-associated fastening elements comprise at least two filter element-associated fastening elements comprising different radial distances in relation to the fastening element center axis of the filter element.

5. The filter element according to claim 1, wherein the two or more filter element-associated fastening elements comprise at least two filter element-associated fastening elements arranged at an identical radial distance in relation to the fastening element center axis of the filter element.

6. The filter element according to claim 1, wherein the two or more filter element-associated fastening elements comprise at least two filter element-associated fastening elements spaced apart from each other at an identical radian or an identical degree measure and further comprise at least two filter element-associated fastening elements spaced apart from each other at an unequal radian or an unequal degree measure.

7. The filter element according to claim 1, wherein the two or more filter element-associated fastening elements comprise:
at least two filter element-associated fastening elements spaced apart from each other at an identical radian or an identical degree measure; or
at least two filter element-associated fastening elements spaced apart from each other at an unequal radian or an unequal degree measure.

8. The filter element according to claim 1, wherein the two or more filter element-associated fastening elements comprise at least two filter element-associated fastening elements arranged with axis symmetry in relation to the fastening element center axis of the filter element and further comprise at least two filter element-associated fastening elements arranged with rotational symmetry in relation to the fastening element center axis of the filter element.

9. The filter element according to claim 1, wherein the two or more filter element-associated fastening elements comprise:
at least two filter element-associated fastening elements arranged with axis symmetry in relation to the fastening element center axis of the filter element; or
at least two filter element-associated fastening elements arranged with rotational symmetry in relation to the fastening element center axis of the filter element.

10. The filter element according to claim 1, wherein the two or more filter element-associated fastening elements are hook-shaped elements.

11. The filter element according to claim 10, wherein the hook-shaped filter element-associated fastening elements each comprise a hook leg with a rectangular or a trapezoidal cross section tapering toward a coupling region, wherein the coupling region comprises at an underside thereof a contact surface, the contact surface projects away from the hook leg, and the coupling region comprises slanted guide surfaces at a topside thereof.

12. The filter element according to claim 1, wherein the one or more end disks comprise a first end disk and a second end disk, wherein the second end disk is arranged at an end of the filter medium facing away from the first end disk.

13. The filter element according to claim 1, further comprising a center tube,
wherein the filter medium surrounds the center tube, and
the at least one further center axis, in relation to which the fastening element center axis of the filter element is radially offset, comprises a center tube center axis of the center tube.

14. The filter element according to claim 13, further comprising at least one guide element,
wherein the one or more end disks comprise a first end disk and a second end disk, wherein the second end disk is arranged at an end of the filter medium facing away from the first end disk,
the at least one guide element is arranged at one or more elements selected from the group consisting of the first end disk, the second end disk, a jacket of the filter element, and the center tube, and
the at least one guide element is configured to define a definite angle positioning of the filter element in relation to the filter housing part at which the filter element is arranged in the state of use.

15. The filter element according to claim 14, wherein the at least one guide element is embodied as a radial protrusion or as an indentation at an outer circumference of the one or more elements selected from the group consisting of the first end disk, the second end disk, the jacket of the filter element, and the center tube.

16. A filter housing part for a filter system, the filter housing part comprising:
an interior configured to accommodate, at least partially, a filter element in a state of use, wherein the filter element comprises two or more filter element-associated fastening elements arranged concentrically around a fastening element center axis of the filter element;
an opening coupled to the interior and comprising at least one opening center axis extending in a longitudinal direction; and
two or more housing part-associated fastening elements arranged concentrically around a fastening element center axis of the filter housing part extending in the longitudinal direction, wherein the fastening element center axis of the filter housing part is radially offset in relation to at least one further center axis extending in the longitudinal direction,
wherein the at least one further center axis comprises at least one filter housing part center axis of the filter housing part extending in the longitudinal direction, or the at least one further center axis comprises at least one filter element center axis of the filter element arranged in the interior in the state of use, wherein the at least one filter element center axis extends in the longitudinal direction, or the at least one further center axis comprises at least one filter housing part center axis of the filter housing part extending in the longitudinal direction and at least one filter element center axis of the filter element arranged in the interior in the state of use, wherein the at least one filter element center axis extends in the longitudinal direction,
the two or more housing part-associated fastening elements comprise a different radial distance in relation to the at least one further center axis, in relation to which the fastening element center axis of the filter housing part is offset,
the fastening element center axis of the filter element in the state of use is congruently arranged in relation to the fastening element center axis of the filter housing part and the two or more housing part-associated fastening elements engage the two or more filter element-associated fastening elements in the state of use.

17. The filter housing part according to claim 16, wherein the two or more housing part-associated fastening elements comprise at least two housing part-associated fastening elements comprising different radial distances in relation to the fastening element center axis of the filter housing part.

18. The filter housing part according to claim 16, wherein the two or more housing part-associated fastening elements comprise at least two housing part-associated fastening elements arranged at an identical radial distance in relation to the fastening element center axis of the filter housing part.

19. The filter housing part according to claim 16, wherein the two or more housing part-associated fastening elements comprise at least two housing part-associated fastening elements spaced apart from each other at an identical radian or an identical degree measure, and further comprise at least two housing part-associated fastening elements spaced apart from each other at a different radian or a different degree measure.

20. The filter housing part according to claim 16, wherein the two or more housing part-associated fastening elements comprise:
at least two housing part-associated fastening elements spaced apart from each other at an identical radian or an identical degree measure; or
at least two housing part-associated fastening elements spaced apart from each other at a different radian or a different degree measure.

21-30. (canceled)
